(19) United States
(12) Patent Application Publication
(10) Pub. No.: US 2005/0035928 A1
(43) Pub. Date: Feb. 17, 2005

(54) Method of an apparatus for driving a plasma display panel

(76) Inventor: Petrus Maria De Greef, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/502,381

(22) PCT Filed: Jan. 15, 2003
(86) PCT No.: PCT/IB03/00079

(30) Foreign Application Priority Data
Jan. 23, 2002 (EP) 02075277.0

(51) Int. Cl. G09G 3/28

(52) U.S. Cl. 345/60

(57) ABSTRACT

The present invention relates to a method and a device for driving a display panel, in particular a plasma display panel (PDP), including cells each corresponding to a pixel in response to a video signal including fields wherein each field is formed by a plurality of subfields, wherein during the processing of a current field the number of subfields per field is adjusted (RU) for a next field in accordance with predetermined parameters.

### FIELD OF THE INVENTION

The present invention relates to a method and device for driving a display panel, in particular a plasma display panel, including cells each corresponding to a pixel in response to a video signal including fields wherein each field is formed by a plurality of subfields, comprising the step of adjusting the number of subfields per field in accordance with predetermined parameters. The present invention also relates to a display panel apparatus, in particular a plasma display panel apparatus, which comprises the mentioned device.

### BACKGROUND OF THE INVENTION

In recent years, a thin display apparatus has been requested in conjunction with an increase in size of the display panel. The plasma display panel (hereinafter simply referred to as“TDP”) is expected to become one of the most important display devices of the next generation which replaces the conventional cathode ray tube, because the PDP can easily realize reduction of thickness and weight of the panel and the provision of a flat screen shape and a large screen surface.

In the PDP, which makes a surface discharge, a pair of electrodes is formed on an inner surface of a front glass substrate and a rare gas is filled within the panel. When a voltage is applied across the electrodes, a surface discharge occurs at the surface of a protection layer and a dielectric layer formed on the electrode surface, thereby generating ultraviolet rays. Fluorescent materials of the three primary colors red, green and blue are coated on an inner surface of a back glass substrate, and a color display is made by exciting the light emission from the fluorescent materials responsive to the ultraviolet rays.

The PDP comprises a plurality of column electrodes (address electrodes) and a plurality of row electrodes arranged so as to intersect the column electrodes. Each of the row electrodes pairs and the column electrodes are covered by a dielectric layer against a discharge space and have a structure such that a discharge cell corresponding to one pixel is formed at an intersecting point of the row electrode pair and the column electrode. Since the PDP provides a light emission display by using a discharge phenomenon, each of the discharge cells has only two states; a state where the light emission is performed and a state where it is not performed. A sub-field method is used to provide a halftone luminance display by the PDP. In the sub-field method, a display period of one field is divided into N sub-fields, a light emitting period having a duration period corresponding to a weight of each bit digit of the pixel data (N bits) is allocated every sub-field, and the light emission driving is performed.

The discharge is achieved by adjusting voltages between the column and row electrodes of a cell composing a pixel. The amount of discharged light changes to adjust the number of discharges in the cell. The overall screen is obtained by driving in a matrix type a write pulse for inputting a digital video signal to the column and row electrodes of the respective cells, a scan pulse for scanning a sustain pulse for sustaining discharge, and an erase pulse for terminating discharge of a discharged cell. Also, a gray scale is implemented by differentiating the number of discharges of each cell for a predetermined time required for displaying the entire picture.

The luminance of a screen is determined by the brightness for the case when each cell is driven to a maximum level. To increase the luminance, a driving circuit must be constructed such that the discharge time of a cell can be maintained as long as possible for a predetermined time required for forming a screen. The contrast, which is a difference in light and darkness, is determined by brightness and luminance of a background such as illumination. To increase the contrast, the background must be dark and the luminance thereof must be increased.

In common PDP display systems, a frame or field of a video signal information is displayed as a set of subfields. The subfields are often driven according the Address Display Separated (ADS) driving scheme. Each subfield has its own address, sustain and erase period. The erase period produces a small quantity of light on the complete display area Active addressing of a pixel-element creates one light-flash in the addressed pixel-element. Only the sustain-period generates light on request, controlled by a number of sustain-pulses. While only the sustain-period generates useful light, the time for addressing and erasing should be minimized in order to allow the display to generate more light.

A considerable amount of time is needed to create sufficient sustain-pulses in plasma display panels in order to achieve a high peak brightness comparable to that of conventional cathode ray tubes.

Options to increase the peak brightness could be achieved by the provision of shorter erase pulses, shorter line-address time and/or shorter sustain-pulses. However, these measures have a negative impact on the panel performance.

The maximum amount of sustain, however, is not only limited by available frame-time, but also by overload of the power supply and high temperature of the panel. These parameters become limiting when frames with high image-load are displayed. When reducing the number of subfields per frame, peak-brightness is exchanged with color-depth.

For changing scenes the sustain-per-time must change gradually from one level to another, while “pumping” of the nominal luminance of a scene must be avoided. This is independent of the number of subfields being driven.

Classic adaptive regulations, which control the number of subfields, measure the image-load of the incoming current frame and use it to control the number of subfields used for displaying that current frame. The regulation uses the image-load to estimate dissipation and temperature and determines a value for the number of subfields to be used. Then it updates the setting of Dithering, Subfield Generation, Partial Line Doubling, Motion Compensated Subfields and Timing & Control blocks accordingly.

In particular, existing driving schemes use a feed forward regulation driven by the videoload measured during the video-processing. This means that a video frame-memory is required while the video-load of a complete frame must be measured, before a specific number of subfields per frame can be generated. A conventional PDP driving system including such a feed forward regulation is shown in FIG. 1. FIG. 1 shows a sub-field load unit SL, a frame delay FD, a video processing unit VP, a sub-field processing unit SP, a sub-field transpose unit ST, a plasma display panel PDP, a SF/sustain level regulation unit RU, and a timing & control generator T&CG. A video timing signal VT, a temperature signal T, and a power-limit signal P are applied to the SF/sustain level regulation unit RU.

WO 99/30309 discloses a display apparatus capable of adjusting the number of subfields to brightness of a plasma display panel. Image brightness data are acquired, and the number of subfields is adjusted on the basis of such brightness data in a feed forward system. So, image characteristics per frame are determined while delaying the video signal.

EP 0 653 740 A2 describes a method of controlling the gray scale of a plasma display device. This known method comprises a forming step of forming a frame for an image by a plurality of subframes each having a different brightness, a setting step of setting the number of sustain emissions of the each subframe individually for each subframe, and a displaying step for displaying the image on the plasma display device by a gray scale display having a specific brightness. The number of sustain emissions in each subframe is set individually by the individual subframe, and this can establish a linear relation between the gray level and the corresponding brightness. So, the number of sustain-pulses in the subframes is adapted on the basis of actually measured data of brightness and consumed current.

EP 0 831 643 A2 discloses a plasma display panel and method of controlling brightness. This plasma display panel has brightness display ranges comprising a gradation brightness display range which displays gradation brightness corresponding to the input signals under a present input signal level and a constant peak brightness display range which displays a constant peak brightness greater than the maximum brightness corresponding to input signals greater than the present input signal level. The plasma display panel can provide the gradation display up to the maximum brightness corresponding to the input signals up to the maximum input signal level and provide the constant peak brightness corresponding to the peak level input by adding one additional weighting bit for the higher gradation. So, the brightness is controlled by adding an extra subfield.

Besides the provision of the above mentioned video frame-memory another disadvantage of the conventional systems is that only later in the image processing stream, it is known which driving-scheme can be used best to drive the PDP display. This scheme may not match with the subfields/frame number derived by the feed forward control (e.g. a low video image-load allows for limited number of subfields and high sustain-level, versus a high panel temperature limiting the sustain-level). When these constraints do not match, the image-performance will drop.

As stated, in the backend of the PDP display system, there are more factors that may limit the amount of sustain per time. This limit allows the panel to be driven at maximum performance, without damaging it. Excessive panel-temperature and power supply voltage-ripple may lead to unused sustain-time, which could have been used to display an extra subfield.

### SUMMARY OF THE INVENTION

It is an object of the present invention to avoid the above mentioned drawbacks and to provide a method and a device for driving a display panel which in particular allow the number of generated subfields to match with an optimal driving scheme and result in optimal luminance and color-depth setting. The invention provides a plasma display driving as defined by the independent claims. The dependent claims define advantageous embodiments.

According to the teaching of the present invention, the number of the subfields per frame is adjusted or generated not for the currently processed field, but for the next field in accordance with predetermined parameters. So, the construction of the present invention results in the provision of a feedback loop that does not deteriorate the visual image quality. The varying number of subfields provides an adaptive trade-off between peak brightness and color-depth.

An advantage of the present invention is that the number of the adjusted or generated subfields will always match with the optimal driving scheme. This results in an optimal luminance and color-depth setting.

Further, the present invention reduces memory and bandwidth requirements since there is no need for a video frame-delay (frame-memory). In particular, there is no need for an extra frame memory. So, the present invention results in hardware and cost savings.

Finally, the present invention allows a feasible implementation. In particular, the present invention can be combined with all other display panel image techniques and in particular PDP image improvement techniques.

It is noted at that in the present text the term “field” can also mean a frame, and the term “subfield” (SF) can also mean a subframe. However, the present invention also covers a situation where a frame of a video signal consists of subframes, and a subframe consists of subfields.

Further, it is noted that the present invention can be applied not only to PDP panels, but also to other subfield driven displays as well as to integrated circuits for panel processing and driving.

Usually, the adjusting step is part of a regulation step for regulating the number of subfields per field in accordance with predetermined parameters. So, the present invention provides for a feedback loop regulation to regulate the number of subfields per field that will be generated for the next field without deterioration of the visual image quality.

In case a plasma display panel including discharge cells is driven wherein a sustain-level signal is applied to cause a sustaining discharge in a discharge cell for emitting light therefrom and the sustain-level is regulated, the adjusting step can be part of the sustain-level regulating step.

Preferably the regulation is an adaptive regulation. In particular, the varying number of subfields provides an adaptive trade-off between the peak brightness and color-depth of PDP displays, which will improve the overall performance.

In case a plasma display panel including discharge cells is driven wherein a sustain-level signal is applied to cause a sustaining discharge in a discharge cell for emitting light therefrom, the predetermined parameters include parameters which have an impact on the sustain-per-time level. In particular, the predetermined parameters can include image-load, temperature and/or power supply capabilities.

Usually, the next field for which the number of the subfields is adjusted is the succeeding field, namely the field following the field that is currently processed when adjusting the number of the subfields.

A preferred embodiment of the device for driving a display panel according to the present invention comprises memory means for storing the fields which memory means includes a dual-port memory for storing more than two fields. The temporary stretching of the display field period allows a gradual reduction of luminance. The memory can be used to de-couple the display field rate from the input video field rate. This applies that the memory is not just a double buffered memory, but a dual-port memory that can store more than two fields of data. This memory can also be used to compensate for timing variations in the input video-stream. When it is combined with a small FIFO (for clock de-coupling) and handshaking in a video-processing stream (for synchronous design), it omits the (timing) need for a video field memory.

### BRIEF DESCRIPTION OF THE DRAWING

In the following, the present invention will be described in greater detail based on a preferred embodiment with reference to the accompanying drawings, in which:

FIG. 1 is a schematic block diagram of a conventional PDP driving system including a feed-forward regulation;

FIG. 2 is a schematic block diagram of a PDP driving system according to a preferred embodiment of the present invention; and

FIGS. 3a and 3b are schematic block diagrams of a subfield frame memory provided as a double buffer memory in a first example (a) and a FIFO memory in a second example (b).

### DESCRIPTION OF THE PREFERRED EMBODIMENT

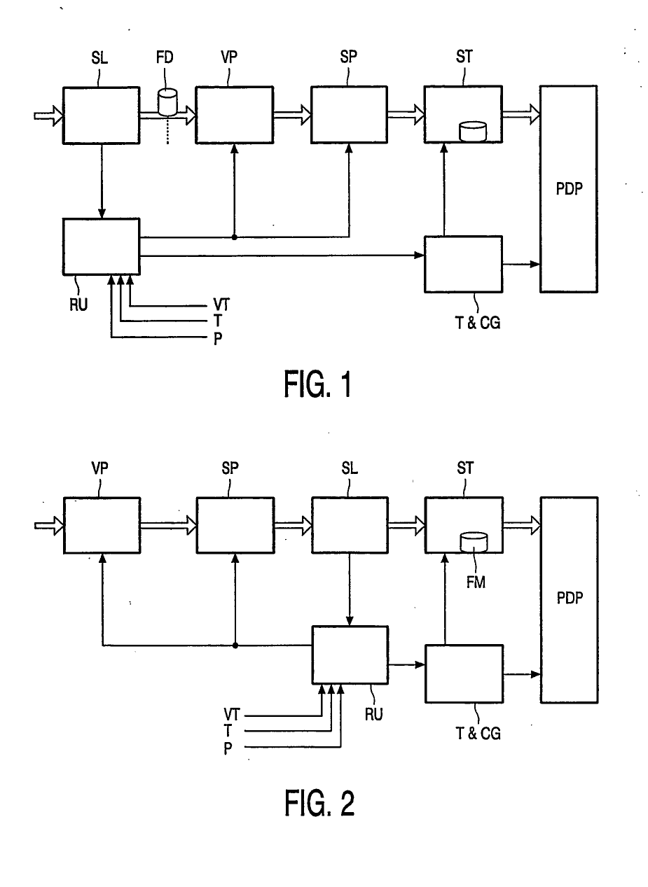

An implementation of an Adaptive SubFields FeedBack (ASFFB) loop technique for an adaptive regulation of the number of subfields per field which drive a plasma display panel (PDP) display according to a preferred embodiment of the present invention is shown as block diagram in FIG. 2. FIG. 2 basically contains the same elements as FIG. 1, but differently arranged. Also, the frame delay FD of FIG. 1 is gone, while the sub-field transpose unit ST now contains a SF frame memory FM.

All parameters that have an impact on the sustain-per-second level are used as input for the sustain-level regulation process carried out in the Sustain Level Regulation module RU. This central process uses direct data (temperature) and indirect data (subfield load) to regulate the sustain-per-second level. This information must be processed before the frame is being displayed in the PDP module. When the frame is retrieved from the subfield transpose (frame-delay), the new settings of the Timing & Control Generator module T&CG must have been defined.

This information can also be used to regulate the number of subfields per frame, which will be generated for the next frame. This is a feedback regulation that does not deteriorate the visual image quality. The varying number of subfields provides an adaptive trade-off between the peak brightness and color-depth of the PDP display. For a lot of video scenes this feedback works fine, while the next image will resemble the current image.

When a scene changes rapidly its luminance-level and causes a change from a few to many subfields per frame, there would be a conflict. There will be no time to decrease the sustain-level gently, which would result in a luminance-step.

Temporary stretching the display frame-period allows a gradual reduction of luminance. The subfield frame-memory can be used to de-couple the display frame-rate from the input video frame-rate. The frame memory is not just a double buffered memory, but also a dual-port memory, which can store more than two frames of data. This memory can also be used to compensate for timing variations in the input video-stream. When it is combined with a small FIFO (for clock-de-coupling) and handshaking in video-processing stream (for synchronous design), it omits the (timing) need for a video frame-memory.

The number of subfields per frame is calculated by the Sustain Level Regulation module RU and looped back to the Video Processing module VP and the Sub-Field Processing module SP. The following input frame is processed accordingly. So, as shown in FIG. 2, the Sustain Regulation module RU is part of the feedback loop providing the above mentioned feedback regulation. Next, the sustain-level information is forwarded to the Timing & Control process carried out in the Timing & Control Generator module T&CG. Before the first subfield of the frame is displayed in the PDP module, the related sustain-time per subfield is calculated. While the regulation is executed by a micro-controller, only software needs to be updated.

As schematically shown in FIG. 2, the Subfield Transpose module ST includes a SF (subfield) frame memory FM that can be used to store some frames. They can be used to allow for a temporary change of the input video-rate and the display frame-rate. This can be used to compensate for possible effects caused by a possible temporary lack of sustain-time.

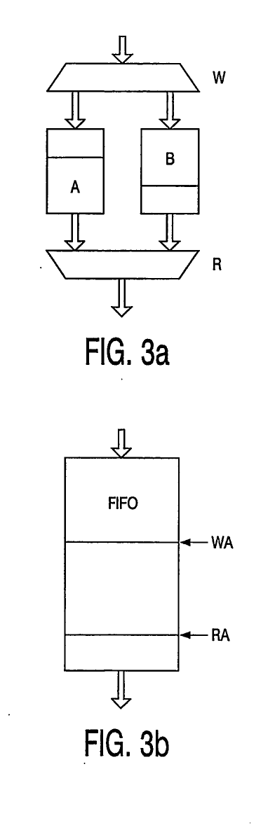

The subfield frame memory can be implemented as a double buffer memory as schematically shown in FIG. 3a. The double buffered subfield memory swaps an A memory and a B memory during the blanking-time (write and read idle) by means of a write switch W and a read switch R. This implies that the display-rate is equal to the input video-rate.

The implementation of the subfield frame memory can be changed from double buffer to FIFO without increase of costs. Such a FIFO memory is shown in FIG. 3b, with write address WA and read address RA. When a FIFO implementation is used for the subfield frame memory, it can act as buffer allowing temporary differences in the input video-rate and display-rate.

The micro-controller also takes care of the Timing and Control process and, thus, includes the Timing and Control Generator module, too. This process must model the speed in which the possible extra luminance can be used, in the same way as it adaptively controls luminance reduction due to power-load and temperature constraints. For example, when timing constraints allow so, the luminance can be adapted with e.g. maximum 1% per frame.

The images of video and data-graphics applications have variations in their active content and load.

Data-graphics applications often use only a set of colors from a pallet. These may only require a limited set of subfields to give nice colors allowing high sustain-level. However these applications have an average image load of about 30%. So, dissipation and temperature will be the limiting factor.

Video-applications have an average image load of about 15%. Subfield distributions tend to have many unused subfield-combinations to reduce image artifacts. A lot of subfields are required and in a subfield many pixels will be inactive. So, a high sustain-level per subfield is allowed. However, time will be the limiting factor.

For video application some specific scenes demand a high brightness to improve the perceived image quality. For example a dark scene with some sparkling lights requires sufficient gray-levels in dark areas (many subfields) and also sufficient peak brightness. In this case the power-supply and temperature will not be the limiting factors; only the limited sustain-time is the real constraint.

Although the invention is described above with reference to an example shown in the attached drawing, it is apparent that the invention is not restricted to it, but can vary in many ways within the scope disclosed in the attached claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A method for driving a display panel including cells each corresponding to a pixel in response to a video signal including fields wherein each field is formed by a plurality of subfields, the method comprising the step of
adjusting the number of subfields per field in accordance with predetermined parameters
characterized in that during the processing of a current field, in said adjusting step the number of the subfields is adjusted for a next field.

2. A device for driving a display panel including cells each corresponding to a pixel in response to a video signal including fields wherein each field is formed by a plurality of subfields, the device comprising
means for adjusting the number of subfields per field in accordance with predetermined parameters
characterized in that said adjusting means is provided for adjusting the number of the subfields for a next field during the processing of a current field.

3. The device according to claim 2, wherein said adjusting means is part of a regulating means for regulating the number of subfields per field in accordance with predetermined parameters.

4. The device according to claim 2, for driving a plasma display panel including discharge cells, the device comprising
means for applying a sustain-level signal to cause a sustaining discharge in a discharge cell for emitting light therefrom, and
means for regulating the sustain-level,
characterized in that said adjusting means is part of said sustain-level regulating means.

5. The device according to claim 3, characterized in that the regulation is an adaptive regulation.

6. The device according to claim 2, for driving a plasma display panel including discharge cells, the device comprising
means for applying a sustain-level signal to cause a sustaining discharge in a discharge cell for emitting light therefrom,
characterized in that said predetermined parameters include parameters which have an impact on the sustain-per-time level.

7. The device according to claim 2, characterized in that said predetermined parameters include image-load temperature and/or power-supply capabilities.

8. The device according to claim 2, characterized in that the next field is a succeeding field.

9. The device according to claim 2, further comprising memory means for storing the fields, characterized in that said memory means comprises a dual-port memory for storing more than two fields.

10. A display panel apparatus comprising the device according to claim 2.
